(19) United States
(12) Patent Application Publication
(10) Pub. No.: US 2008/0143840 A1
(43) Pub. Date: Jun. 19, 2008

(54) Image Stabilization System and Method for a Digital Camera

(75) Inventors: David L. Corkum, Attleboro, MA (US); Aziz U. Batur, Dallas, TX (US); Douglas Strott, Plainville, MA (US); Leonardo Estevez, Rowlett, TX (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/959,718

(22) Filed: Dec. 19, 2007

Related U.S. Application Data
(60) Provisional application No. 60/870,693, filed on Dec. 19, 2006.

(51) Int. Cl. H04N 7/18

(52) U.S. Cl. 348/208.6; 348/208.99; 348/E05.046

(57) ABSTRACT

Deblurring digital camera images captured in low-light, long-integration-time conditions by capturing multiple short-integration images and fusing with on-the-fly motion estimation and alignment to limit the frame memory requirements. In one embodiment, an image stabilization system includes: (1) a frame memory and (2) a processor coupled to the frame memory and configured to store a first short-integration digital image in the frame memory, determine a displacement of a second short-integration digital image relative to the first short-integration digital image, combine the second short-integration digital image with the first short-integration digital image to form a fused digital image and overwrite the first short-integration digital image with the fused digital image.

### CROSS-REFERENCE TO PROVISIONAL APPLICATION

This application claims the benefit of U.S. Provisional Application Ser. No. 60/870,693, filed Dec. 19, 2006, by Corkum, et al., entitled “Digital Camera and Method,” commonly assigned with the invention and incorporated herein by reference.

### TECHNICAL FIELD OF THE INVENTION

The invention is directed, in general, to digital video signal processing and, more specifically, to an image stabilization system and method for a digital camera.

### BACKGROUND OF THE INVENTION

Still imaging and video devices have become a significant part of consumer electronics. Digital cameras, digital camcorders, and video cellular phones are common, and many other new devices are being introduced into and evolving in the market continually. Advances in large resolution charge-coupled device (CCD) and complementary metal-oxide semiconductor (CMOS) image sensors, together with the availability of low-power, low-cost digital signal processors (DSPs), has led to the development of digital cameras with both high resolution (e.g., a five-megapixel image sensor with a 2560×1920 pixel array) still image and audio/video clip capabilities. In fact, high resolution digital cameras provide quality close to that offered by traditional 35 mm film cameras.

Typical digital cameras provide a capture mode with full resolution image or audio/video clip processing plus compression and storage, a preview mode with lower resolution processing for immediate display and a playback mode for displaying stored images or audio/video clips.

CCD or CMOS image sensors integrate energy from the light they receive and therefore require time to acquire an image. The integration time increases as the available light decreases. Therefore, when a digital image is captured indoors (a typical low-light condition) and the subject is at a distance from the camera, any use of zoom magnification without a tripod will cause the image to be blurred due to operator jitter during the increased integration time. In general, low-light conditions require long exposure times (time for charge integration in a CCD or CMOS image sensor) to yield an acceptable signal-to-noise ratio. To exacerbate matters, only a portion of the image sensor is used with electronic zoom, so the integration time is further multiplied.

Some digital cameras measure and attempt to compensate for operator jitter. A number of commercially available digital cameras have lens assemblies that employ actuators to tilt or laterally translate lenses to compensate for image blurring caused by relative motion between the scene and focal plane. Some camera-based motion sensors are capable of compensating for specific motions of the camera within an inertial frame. Unfortunately, these are particularly expensive. Although motion sensors are becoming less expensive and smaller, the overall motion-compensating optical systems in which they operate are usually large and expensive. Providing the same image stabilization functionality without requiring a mechanical compensation mechanism is highly desirable.

Accordingly, what is needed in the art is an image stabilization system and method for a digital camera that avoids a mechanical compensation mechanism. In general, what is needed in the art is an image stabilization system and method for a digital camera that provides effective compensation for operator jitter that is smaller or costs less than a mechanical compensation mechanism.

### SUMMARY OF THE INVENTION

To address the above-discussed deficiencies of the prior art, the invention provides digital camera image deblurring by combining (“fusing”) short-integration images with immediate motion estimation for concurrent short-integration image read out, alignment and fusion with prior short-integration images.

One aspect of the invention provides an image stabilization system. In one embodiment, the system includes: (1) a frame memory and (2) a processor coupled to the frame memory and configured to store a first short-integration digital image in the frame memory, determine a displacement of a second short-integration digital image relative to the first short-integration digital image, combine the second short-integration digital image with the first short-integration digital image to form a fused digital image and overwrite the first short-integration digital image with the fused digital image.

Another aspect of the invention provides an image stabilization method. In one embodiment, the method includes: (1) storing a first short-integration digital image in a frame memory, (2) determining a displacement of a second short-integration digital image relative to the first short-integration digital image, (3) combining the second short-integration digital image with the first short-integration digital image to form a fused digital image and (4) overwriting the first short-integration digital image with the fused digital image.

Yet another aspect of the invention provides a digital camera. In one embodiment, the digital camera includes: (1) an image sensor configured to provide at least five successive short-integration digital images, (2) a frame memory and (3) a processor coupled to the frame memory and configured to store an initial one of the short-integration digital images in the frame memory, successively determine displacements of subsequent ones of the short-integration digital images relative to the initial one of the short-integration digital image as the image sensor is providing the short-integration digital images and successively combine the subsequent ones of the short-integration digital images with the initial one of the short-integration digital images to form a fused digital image as the image sensor is providing the short-integration digital images.

Still another aspect of the invention provides a method of digital camera operation. In one embodiment, the method includes: (a) sequentially capturing a plurality of images, I₁, I₂, . . . , I_{N}, of a scene where N is an integer greater than 2 and image Iₙ has an integration time of Tₙ for n=1, 2, . . . , N, (b) estimating motion of each of the Iₙ, the estimating prior to the time of beginning readout of the pixel values of the Iₙ from an image sensor and (c) using the estimated motion to combine pixel values of Iₙ with corresponding pixel values of Fₙ₋₁, where Fₙ₋₁ is a fusion of I₁, I₂, . . . , I_{N-1}, and the combining results in Fₙ, the combining of at least one-half of the pixel values of Iₙ with corresponding pixels of Fₙ₋₁ to form Fₙ occurs prior to the completion of the readout of the pixel values of Iₙ.

### BRIEF DESCRIPTION OF THE DRAWINGS

For a more complete understanding of the invention, reference is now made to the following descriptions taken in conjunction with the accompanying drawings, in which:

FIG. 1 is a high level block diagram of one embodiment of a digital camera having a motion sensor and forming an environment within which an image stabilization system and method constructed or carried out according to the principles of the invention may operate;

FIG. 2 is a block diagram illustrating prior-art front-end image processing as carried out by one embodiment of the digital camera of FIG. 1;

FIG. 3 is a block diagram illustrating one embodiment of circuitry contained in the digital camera of FIG. 1;

FIG. 4 is a block diagram illustrating one embodiment of network communication carried out by the digital camera of FIG. 1;

FIG. 5 is a schematic illustration of one embodiment of an image capture sequence carried out according to the principles of the invention; and

FIG. 6 is a flow diagram of one embodiment of an image stabilization method carried out according to the principles of the invention.

### DETAILED DESCRIPTION

U.S. patent application Ser. No. 11/300,818, filed by Estevez, et al. on Dec. 15, 2005, entitled “A Multi-Frame Method for Preventing Motion Blur” and incorporated herein by reference describes a recent solution to the problem of image blur: a digital image processing technique that calls for multiple images with low exposure (or “integration”) to be captured, stored, analyzed and then combined (“fused”) together to yield an image representing a higher exposure or integration.

For example, if the ideal exposure time for a given lighting condition is E, N sequential images could be captured and stored in a burst mode with exposure times (1/N)*E. While each of these images would be expected to have less blur because of their short exposure time, they would also be darker than desired. The first step of the subsequent analysis is to compute the translational motion between these multiple images. Once the motion information is available, the images are then shifted based on the motion information and fused together.

While the digital image stabilization technique described above is effective and avoids a mechanical compensation mechanism, a the frame memory is required to store each of the multiple images. A digital image stabilization system and method that uses less the frame memory would have an additional advantage.

The digital image stabilization system and method disclosed herein enable relatively low cost embodiments to minimize image blur caused by relative motion between a digital camera's focal plane and a scene. The system and method are based on a hybrid technique that uses a motion sensor to detect the hand motion in real time and an image processing technique to fuse multiple images. The motion sensor provides an accurate measurement of the translational motion between the current image and the previous image right before the pixels have been readout from the sensor. The availability of this motion information makes it possible to know where the motion-compensated new image and the previous image should be fused. As a result, the new image need not be stored in the frame memory. As the new image is read out from the sensor row-by-row, it could begin to be fused with the previously captured image.

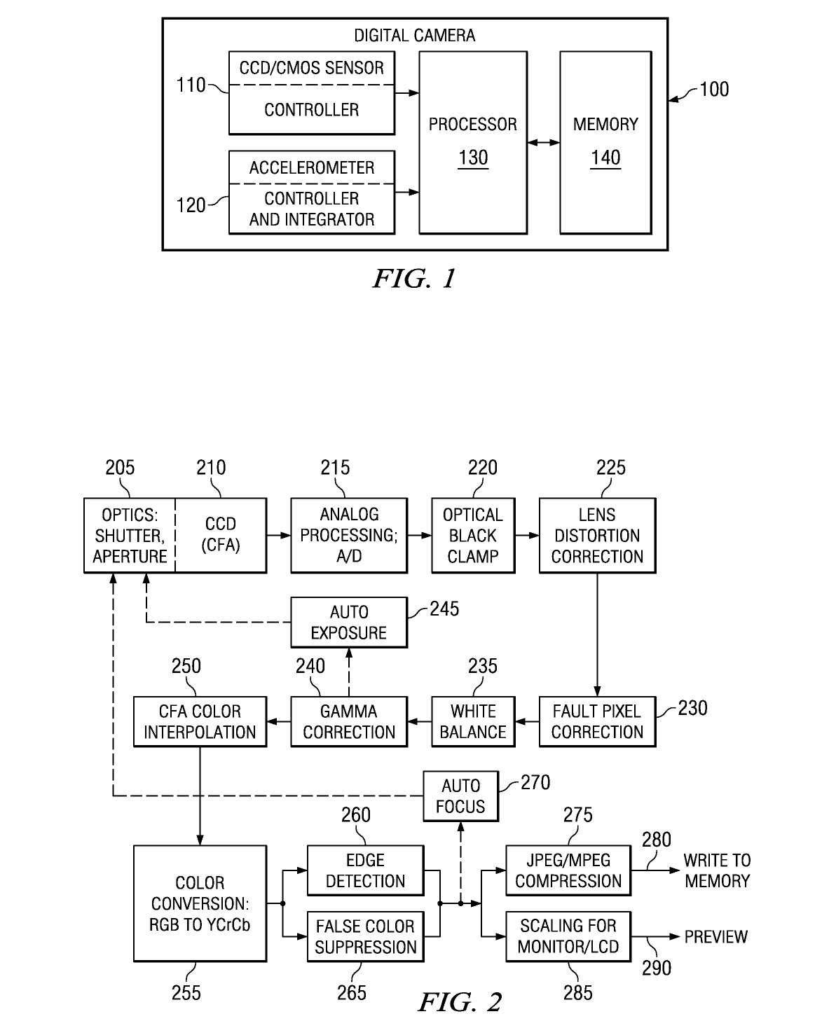

Before describing various embodiments of the system and method, various aspects of a digital camera will be described. FIG. 1 is a high level block diagram of one embodiment of a digital camera having a motion sensor and forming an environment within which an image stabilization system and method constructed or carried out according to the principles of the invention may operate. The camera, generally designated 100, contains a CCD or CMOS image sensor and associated controller 110, a motion sensor, such as an accelerometer, and an associated controller and integrator 120, a processor 130 and a frame memory 140.

For purposes of the invention, “processor” is a broad term encompassing not only general-purpose processors such as microprocessors, coprocessors, DSPs and controllers, but also programmable logic arrays (PALs) and special-purpose digital hardware capable of carrying out one or more of the methods described herein.

FIG. 2 is a block diagram illustrating prior-art front-end image processing as carried out by one embodiment of the digital camera 100. An optical system 205 includes a lens, a shutter and an aperture. A CCD 210 receives an image through the optical system 205. An A/D converter 215 converts the analog output of the CCD 210 to a digital image. An optical black clamp 220 removes residual offsets in the digital image. A lens distortion corrector 225 removes known lens distortion from the digital image. A faulty pixel corrector 230 fills in known faulty pixels in the digital image. A white balancer 235 color-corrects the digital image to adjust the color temperature of the digital image. A gamma corrector 240 adjusts gamma (which relates luminance to pixel level) of the digital image. The resulting digital image is then processed by an auto exposure unit 245 that controls the shutter of the optical system 205. The digital image is also provided to a color filter array (CFA) unit 250, which performs color interpolation on the digital image.

A color converter 255 converts the digital image from one color space (e.g., RGB) to another (e.g., YCbCr). Note that a typical color CCD consists of a rectangular array of photosites covered by a CFA: typically, red, green or blue. In the commonly-used Bayer pattern CFA, one-half of the photosites are green, one-quarter are red, and one-quarter are blue.

An edge detector 260 and a false color corrector 265 respectively detects edges and corrects for false colors in the digital image. The output of the edge detector 260 and the false color corrector 265 is provided to an autofocus (AF) unit 270 that controls the lens of the optical system 205. The output of the edge detector 260 and the false color corrector 265 is provided to a Joint Photographic Experts Group/Motion Picture Experts Group (JPEG/MPEG) compression unit 275 for conversion into the appropriate one of those well-known still image and video compression standards. The compressed output 280 can then be written to external memory (e.g., synchronous dynamic random-access memory, or SDRAM). The output of the edge detector 260 and the false color corrector 265 is also provided to a scaling unit 285 to scale the digital image to preview 290 on a monitor, such as a liquid crystal display (LCD) on the back of the digital camera.

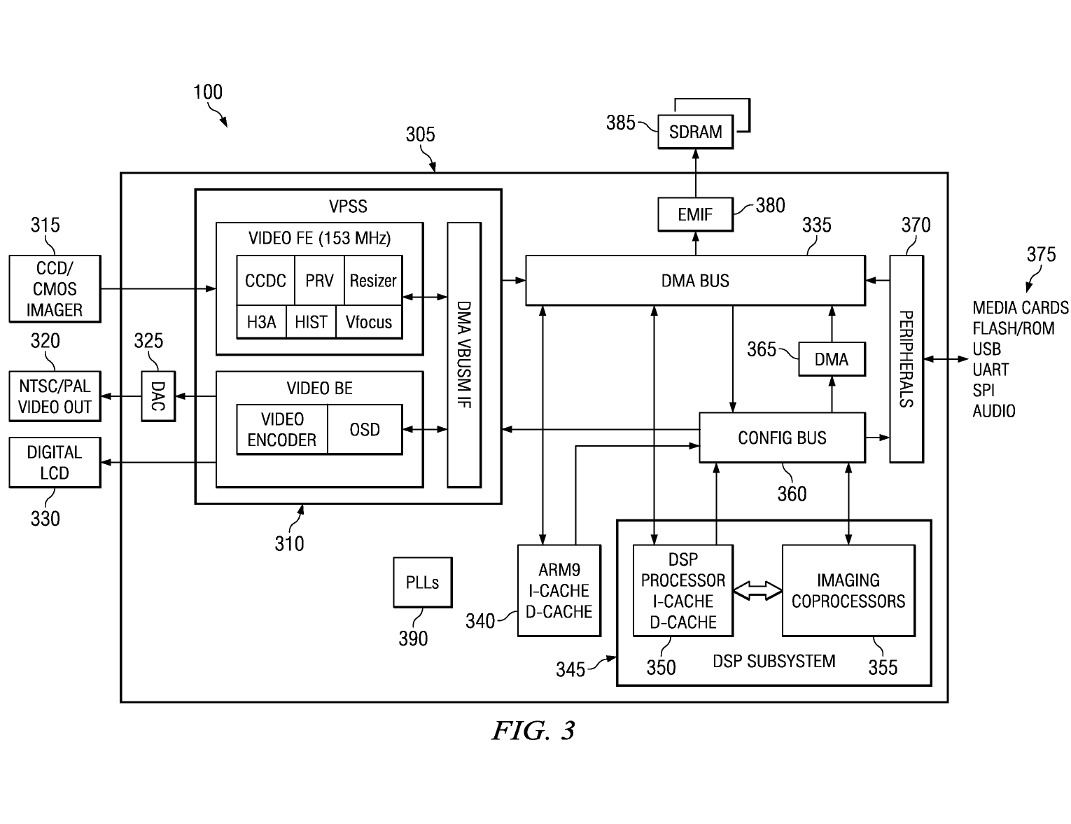

FIG. 3 is a block diagram illustrating one embodiment of circuitry contained in the digital camera 100 of FIG. 1. The digital camera contains image processing circuitry 305. The image processing circuitry 305 contains a video processing subsystem (VPSS) 310 that receives images from a CCD/CMOS image sensor 315 and performs much if not all of the front-end image processing detailed in FIG. 2. The VPSS 310 provides output to a National Television System Committee (NTSC) or Phase Alternating Line (PAL) video output 320, whichever is appropriate, via digital-to-analog converter 325, a digital LCD 330 (typically the LCD on the back of the digital camera 100) and a direct memory access (DMA) bus 335.

The DMA bus conveys data among a processor (e.g., a commercially available ARM9) with its associated instruction and data caches 340, a DSP subsystem 345 (containing a DSP with its associated instruction and data caches 350 and imaging processors 355), a configuration bus 360, a DMA controller 365, various peripheral interfaces 370 and an external memory interface (EMIF) 380. The peripheral interfaces 370 may lead to one or more peripheral devices 375, such as media cards, flash, read-only memory (ROM), a universal serial bus (USB), etc. The EMIF 380 provides an interface to external memory, such as SDRAM 385. Various phase-locked loops (PLLs) 390 provide clock signals to synchronize the operation of the aforementioned circuitry.

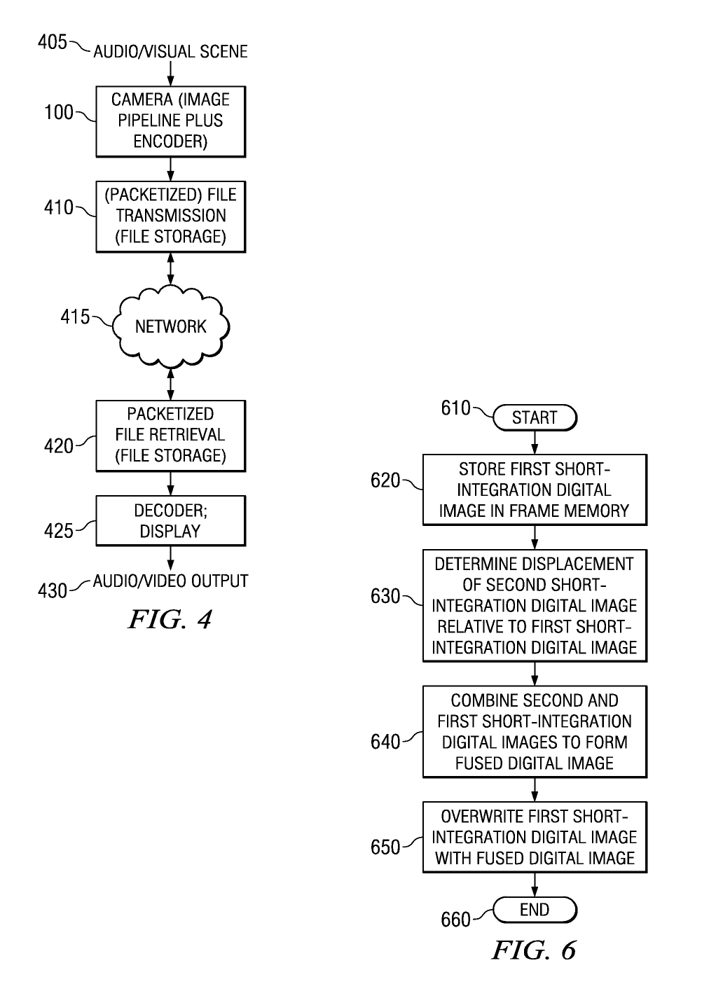

FIG. 4 is a block diagram illustrating one embodiment of network communication carried out by the digital camera of FIG. 1. The digital camera 100 captures an audio-visual scene 405 and creates one or more digital still or video images, perhaps including audio. The digital camera 100 may thereafter divide the digital images into packets and create a transmission 410 to a network 415 to cause them to be stored as one or more files (not shown). The one or more files may thereafter be retrieved, whereupon they are again divided into packets and a transmission 420 created. The retrieved digital images 420 may then be passed through a decoder 425 and displayed as an audio/video output 430.

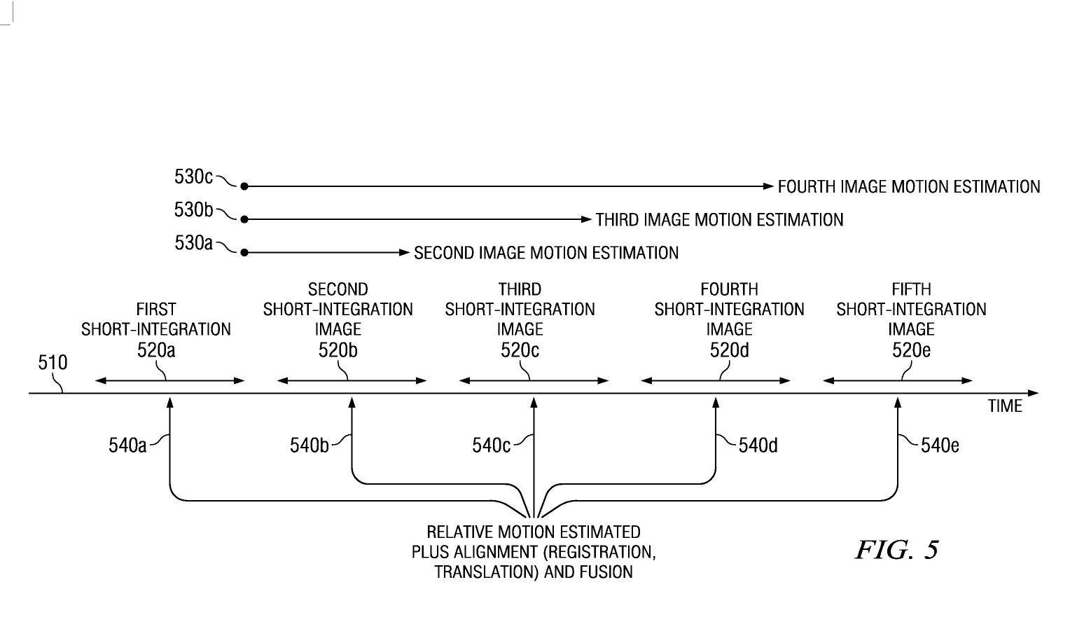

Having described various aspects of a digital camera, various embodiments of the system and method will now be described. FIG. 5 is a schematic illustration of one embodiment of an image capture sequence carried out according to the principles of the invention. FIG. 5 presents a timeline 510 during which first, second, third, fourth and fifth images 520a, 520b, 520c, 520d, 520e of relatively short integration are captured. The first short-integration image 520a is captured and stored in a the frame memory (not shown). During capture of the second short-integration image 520b, a second image motion estimation 530a of the relative motion between the first and second short-integration images 520a, 520b is made from a motion sensor or an analysis of a portion of the second short-integration image 520b. Given the second motion estimation 530a, the first and second short-integration images 520a, 520b are aligned and fused in the frame memory as arrows 540a, 540b indicate.

Likewise, during capture of the third short-integration image 520c, a third image motion estimation 530b of the relative motion between the first and third short-integration images 520a, 520c is made from the motion sensor or an analysis of a portion of the third short-integration image 520c. Given the third motion estimation 530b, the first and third short-integration images 520a, 520c are aligned and fused in the frame memory as arrows 540b, 540c indicate.

In the same manner, during capture of the fourth short-integration image 520d, a fourth image motion estimation 530c of the relative motion between the first and fourth short-integration images 520a, 520d is made from the motion sensor or an analysis of a portion of the fourth short-integration image 520d. Given the fourth motion estimation 530c, the first and fourth short-integration images 520a, 520d are aligned and fused in the frame memory as arrows 540c, 540d indicate.

Implied but not shown in FIG. 5 is that during capture of the fifth short-integration image 520e, a fifth image motion estimation of the relative motion between the first and fifth short-integration images 520a, 520d is made from the motion sensor or an analysis of a portion of the fifth short-integration image 520e. Given the fifth motion estimation, the first and fifth short-integration images 520a, 520e are aligned and fused in the memory as arrows 540d, 540e indicate.

In more detail, if T is the normal exposure (integration) time to capture a desired image, and the environment has very low light, T can be very long (e.g., 550 ms), increasing the possibility of image blurring. Thus, N multiple (e.g., N=10) short-integration images with an exposure time of T/N (e.g., N=10 and T/N=15 ms) may be appropriate to reduce the image blurring. Note that if the exposure time is reduced without making any other adjustments, the images will darker. Therefore, the digital or analog gain is typically increased by a factor of N so the brightness level of the image is preserved. Of course, increasing the digital or analog gain will increase the noise in the image, but post-processing can be employed to reduce that noise.

Once the first short-integration image 520a has been captured (at time=15 ms from the beginning), the output of the motion sensor can begin to be integrated in an accumulator to accumulate the camera displacement for alignment of subsequent short-integration images as they are read out and fused with the frame memory contents. Also, the captured first short-integration image 520a can be read out for storage in memory. Read-out typically takes 200 ms given a typical CCD or CMOS image sensor.

At time=215 ms, the second short-integration image 520b has been captured and is ready for read-out, and the first short-integration image 520a is in the frame memory. Concurrent read out and fusion with the frame memory contents minimizes memory usage and proceeds as follows.

First, the camera displacement from the time of the capture of the first short-integration image 520a to the time of the capture of the second short-integration image 520b (e.g., from time=15 ms to time=215 ms) is obtained from the motion sensor integrator. This yields a motion vector for the second short-integration image 520b relative to the first short-integration image 520a: V⁽²⁾=(Vₓ⁽²⁾, V_{y}⁽²⁾) . That is, the pixel location (m, n) of the second short-integration image 520b corresponds to the pixel location (m−Vₓ⁽²⁾, n−V_{y}⁽²⁾) of the first short-integration image 520a in the frame memory.

If V⁽²⁾ has only pixel accuracy, when the pixel value p⁽²⁾(m, n) is read out, one embodiment of the invention calls for the pixel value to be averaged with the frame memory pixel value p⁽¹⁾(m−Vₓ⁽²⁾, n−V_{y}⁽²⁾ to give a fused pixel value f⁽¹⁾(m−Vₓ⁽²⁾, n−V_{y}⁽²⁾) which is written back to the same location in the frame memory such that the original frame memory pixel value p⁽¹⁾(m−Vₓ⁽²⁾/n−V_{y}⁽²⁾) is overwritten. No change need be made for memory locations with no corresponding pixel locations in the second short-integration image. Conversely, read-out pixel locations in the second short-integration image 520b which have no corresponding pixel locations in the frame memory can be ignored.

If V⁽²⁾ has half-pixel components, one embodiment calls for four the frame memory reads to take place when the pixel value p⁽²⁾(m, n) is read out, and p⁽²⁾(m, n) is a 1:4 weighted averaged with each of the four the frame memory pixel value p⁽¹⁾(m−Vₓ⁽²⁾±½, n−V_{y}⁽²⁾±½) to yield four partially fused pixel values at these locations, which are written back to the frame memory, again overwriting what was previously stored. Three other read-out pixels contribute at each location to give the fused f⁽¹⁾(m−Vₓ⁽²⁾±½, n−V_{y}⁽²⁾±½). When a motion vector component is not a half-integer, half of the frame read/writes may be eliminated.

Of course, for higher resolution motion vectors, weighted averages of neighboring pixel values may be fused. And for color images, the three separate color planes can be separately fused. In the latter case, the averagings are likely over pixel locations within a single color plane.

An alternative with fewer the frame memory read/writes uses a small first-in, first-out (FIFO) buffer to hold a row of read-out pixel values. With the FIFO buffer, a preliminary averaging (such as (p⁽²⁾(m, n)+p⁽²⁾(m+1, n)+p⁽²⁾(m, n+1)+p⁽²⁾(m+1, n+1))/4) can be performed to yield an integer pixel motion vector equivalent of the second short-integration image 520b that precedes the frame memory read. This can then be averaged with the corresponding one of p⁽¹⁾(m−Vₓ⁽²⁾±½, n−V_{y}⁽²⁾±½), and written back to the frame memory.

Similarly, once the third short-integration image 520c has been captured (e.g., time=45 ms), the foregoing displacement acquisition is repeated, the pixel read-out and averaged with the corresponding pixel in the frame memory. However, the averaging is weighted 1:2 because the frame memory contains the fusion of two prior short-integration images.

Likewise for subsequent short-integration images with the averaging weighting of the N^{th} short-integration image being 1:(N−1).

One effective fusing strategy is to accumulate the new image on top of the previous image, which tends to increase image brightness and reduce the effects of sensor noise. Another fusing strategy is to average the new and previous images together. Later, post-processing could be employed to adjust the overall histogram and filter noise as desirable.

Important to the digital image stabilization system and method disclosed herein is to ascertain the correct alignment (registration and translation) of the newly captured image with respect to the previous image relatively quickly and accurately so fusing can begin as soon as possible, preferably as the new image is being read from the image sensor. The motion sensor provides us the required motion information in real-time.

A motion estimation technique may be used to eliminate the requirement for a motion sensor. One technique is based on strategic row selection read-out that stores only a (typically small) portion of the new image in the frame memory. This portion should contain a prominent scene structure to allow an accurate estimation of the motion between the two images. For example, every fifth row could be read out of the image in the center part. This increases the probability that useful images content is inside the region that is read out for motion estimation. Once the motion is calculated, the remainder of the new image can be read out from the image sensor and fused to the previous image, again without requiring additional frame memory to store multiple images.

Another alternative motion estimation technique is to use statistics generated in the normal course by an AF unit, e.g., the AF unit 270 of FIG. 2. Among other things, an AF unit computes a sharpness metric for the digital image and saves the results to memory. The positions of the sharpest features in the scene correspond to the peaks of this sharpness metric. By correlating the locations of these peaks for the new and previous frames, the motion vector could be determined relatively quickly without much computation.

An advantage of the various motion estimation techniques described above is that the motion sensor may be eliminated. A challenge, however, is recovery from a motion estimation error. If motion estimation errors were to occur, the subsequent fusing operation could be done at the wrong location on the previous image and could corrupt the image. A method for recovering from motion estimation errors could be developed to undo the fusing operation and restart it with the correct translation.

FIG. 6 is a flow diagram of one embodiment of an image stabilization method carried out according to the principles of the invention. The method begins in a start step 610. In a step 620, a first short-integration digital image is stored in a frame memory. In a step 630, a displacement of a second short-integration digital image relative to the first short-integration digital image is determined. In a step 640, the second short-integration digital image is combined with the first short-integration digital image to form a fused digital image. In a step 650, the first short-integration digital image is overwritten with the fused digital image. The method ends in a step 660.

Various embodiments of imaging systems (e.g., digital cameras, video cell phones and camcorders) may perform various embodiments of the methods disclosed herein with any of many types of hardware which may include DSPs, general purpose programmable processors, application-specific circuits, or systems on a chip (SoC) such as combinations of a DSP and a reduced instruction set computer (RISC) processor together with various specialized programmable hardware accelerators.

The fusion of the short integration images to the current frame buffer could be implemented more efficiently if the DMA in the digital camera were capable of providing specific support for this task. A DMA that provides the following capabilities would increase implementation efficiency:

(1) A DMA channel that may be configured to add two lines from specified locations as part of its transfer.

(2) A DMA channel that can resample the input data with a subpixel shift while the data is being transferred would help to increase the efficiency of fusing frames with subpixel alignment.

(3) A DMA channel that may be configured to compute a Sum of the Absolute Difference (SAD) between two lines over a specified sliding window and transfer the sum of the values corresponding to the minimum SAD, or return the minimum SAD offset for use by another DMA channel such as the one described in (1) above.

The various embodiments described above may be modified in various ways while retaining the feature of limited memory usage by fusing short-integration images with alignment from real-time motion estimation.

For example, the multiple short-integration images may have varying exposure times (e.g., between 2 and 20 ms). Then, the fusion of these low exposure images could be used to implement dynamic range extension. This process involves changing each image's fusion weight locally according to image contents. The local weight is increased for the image that has more details in that local region. The amount of details could be measured using the entropy of the image which is defined as −sum(p.*log(p)) where p is the local image histogram. Implementation of this method would require the computation of the entropy locally. So, this would require a DMA that can calculate the local entropy and the fusion weight for each image before fusing it into the image buffer. If such a DMA is unavailable, a small circular buffer could be used to compute the entropy for a few lines of the image and then fuse those lines to the frame buffer.

From the above, it is apparent that the disclosed systems and methods deblur captured images by fusing multiple (e.g., 5, 10 or more) short-integration images with real-time displacement (i.e., motion) estimation for alignment of the short-integration images as they are read out from the image sensor; thereby, only a frame memory sufficient to store a single digital image is required. The alignment is by one or more motion estimation from (1) a motion sensor (e.g., an accelerometer) and (2) correlation of significant rows of current short-integration image with corresponding rows of current the frame memory (partially-fused image).

Those skilled in the art to which the invention relates will appreciate that other and further additions, deletions, substitutions and modifications may be made to the described embodiments without departing from the scope of the invention.

What is claimed is:

1. An image stabilization system, comprising:
a frame memory; and
a processor coupled to said frame memory and configured to store a first short-integration digital image in said frame memory, determine a displacement of a second short-integration digital image relative to said first short-integration digital image, combine said second short-integration digital image with said first short-integration digital image to form a fused digital image and overwrite said first short-integration digital image with said fused digital image.

2. The system as recited in claim 1 further comprising a motion sensor configured to provide data to said processor indicating said displacement.

3. The system as recited in claim 2 wherein said motion sensor is an accelerometer and said system further comprises an integrator coupled to said accelerometer and configured to accumulate an output thereof to provide said data.

4. The system as recited in claim 1 wherein said processor is further configured to store only a portion of said second short-integration digital image and determine said displacement from said only said portion and said first short-integration digital image.

5. The system as recited in claim 4 wherein said processor is further configured to store said only said portion in a selected one of:
said frame memory, and
a FIFO buffer.

6. The system as recited in claim 1 wherein said processor is further configured to form said fused digital image from said first and second short-integration digital images and at least three subsequent short-integration digital images.

7. An image stabilization method, comprising:
storing a first short-integration digital image in a frame memory;
determining a displacement of a second short-integration digital image relative to said first short-integration digital image;
combining said second short-integration digital image with said first short-integration digital image to form a fused digital image; and
overwriting said first short-integration digital image with said fused digital image.

8. The method as recited in claim 7 further comprising providing data indicating said displacement from a motion sensor.

9. The method as recited in claim 8 wherein said motion sensor is an accelerometer and said method further comprises accumulating an output thereof to provide said data.

10. The method as recited in claim 7 further comprising storing only a portion of said second short-integration digital image, said determining comprising determining said displacement from said only said portion and said first short-integration digital image.

11. The method as recited in claim 10 wherein said storing comprises storing said only said portion in a selected one of:
said frame memory, and
a FIFO buffer.

12. The method as recited in claim 7 wherein said combining comprises combining said first and second short-integration digital images and at least three subsequent short-integration digital images to form said fused digital image.

13. A digital camera, comprising:
an image sensor configured to provide at least five successive short-integration digital images;
a frame memory; and
a processor coupled to said frame memory and configured to store an initial one of said short-integration digital images in said frame memory, successively determine displacements of subsequent ones of said short-integration digital images relative to said initial one of said short-integration digital image as said image sensor is providing said short-integration digital images and successively combine said subsequent ones of said short-integration digital images with said initial one of said short-integration digital images to form a fused digital image as said image sensor is providing said short-integration digital images.

14. The digital camera as recited in claim 13 further comprising a motion sensor configured to provide data to said processor indicating said displacement.

15. The digital camera as recited in claim 14 wherein said motion sensor is an accelerometer and said digital camera further comprises an integrator coupled to said accelerometer and configured to accumulate an output thereof to provide said data.

16. The digital camera as recited in claim 13 wherein said processor is further configured to store only portions of said subsequent ones of said short-integration digital images and determine said displacement from said only said portions and said initial one of said short-integration digital images.

17. A method of digital camera operation, comprising:
(a) sequentially capturing a plurality of images, I₁, l₂, . . . , I_{N}, of a scene where N is an integer greater than 2 and image Iₙ has an integration time of Tₙ for n=1, 2, . . . , N;
(b) estimating motion of each of said Iₙ, said estimating prior to the time of beginning readout of the pixel values of said Iₙ from an image sensor; and
(c) using said estimated motion to combine pixel values of Iₙ with corresponding pixel values of Fₙ₋₁, where Fₙ₋₁ is a fusion of I₁, I₂, . . . , I_{N-1}, and said combining results in Fₙ, said combining of at least one-half of the pixel values of Iₙ with corresponding pixels of Fₙ₋₁ to form Fₙ occurs prior to the completion of said readout of the pixel values of Iₙ.

18. The method as recited in claim 17 wherein N is in the range of 5-20.

19. The method as recited in claim 17 wherein Tₙ is in the range of 5-15 milliseconds for n=1, 2, . . . , N.

20. The method as recited in claim 17 wherein said combining is of subpixel resolution.
